(19) United States
(12) Patent Application Publication
(10) Pub. No.: US 2013/0086895 A1
(43) Pub. Date: Apr. 11, 2013

(54) Pneumatic Starter Device for Internal Combustion Engines and Method of Operation

(71) Applicants: Sebastian Rakowski, Hannover (DE); Ingo Stumberg, Hannover (DE)

(72) Inventors: Sebastian Rakowski, Hannover (DE); Ingo Stumberg, Hannover (DE)

(73) Assignee: WABCO GmbH, Hannover (DE)

(21) Appl. No.: 13/613,503

(22) Filed: Sep. 13, 2012

(30) Foreign Application Priority Data
Oct. 8, 2011 (DE) 10 2011 115 448.9

(51) Int. Cl. F02N 7/06; F01B 23/02; F01B 25/04

(52) U.S. Cl. 60/327; 123/179.31

(57) ABSTRACT

A pneumatic starter device for an internal combustion engine includes a cylinder-piston assembly, which can be operated either as a compressor or as a starter motor and which is drive-connected to the internal combustion engine. A pressure accumulator and a valve arrangement are associated with this assembly. The valve arrangement, which is between the assembly and the pressure accumulator, can be activated by a control unit and can be switched between a compressor mode and a starter mode. Before the cylinder-piston assembly is started up, it is set to a crank angle position in a range of positions that produce maximum output torque.

### CROSS-REFERENCE TO RELATED APPLICATION

This application claims the benefit of DE 10 2011 115 448.9 filed on Oct. 8, 2011, the disclosure of which is hereby incorporated herein by reference in its entirety. A certified copy of the foregoing is being submitted concurrently with the filing of this application.

### BACKGROUND OF THE INVENTION

The present invention generally is directed to embodiments of a pneumatic starter device for internal combustion engines and a method for operating the device.

Cylinder-piston assemblies that can be operated either as compressors or as motors are widely known. For example, DE 1 281 752 A1 proposes using an assembly of this kind, referred to as an axial piston machine, as a so-called starter motor for starting an internal combustion engine. The axial piston machine is supplied with a pressure medium from a pressure system of the vehicle for operation as a motor. Then, after the internal combustion engine has been started, the axial piston machine is operable as a pump that recharges the pressure system of the vehicle with pressure medium. It is assumed that the axial piston machine is always capable of starting the associated internal combustion engine, i.e., that the output torque required to start the internal combustion engine is available in any random crank angle position of the axial piston machine. However, this is the case for only axial piston machines with a relatively large number of cylinders (i.e., three or more cylinders), where a largely uniform torque profile over the crank angle can be assumed, thus providing a sufficient output torque in any crank angle position.

DE 24 40 446 A1 describes a pneumatic starter device that can be used, in particular, on motor vehicles in which the engine is switched off when the vehicle is stationary, requiring the engine to be restarted in order to drive the vehicle. The pneumatic starter device includes a cylinder-piston assembly, which can be operated either as a compressor or as a starter motor and is drive-connected to the internal combustion engine, a pressure accumulator associated with this assembly, and a valve arrangement, which is arranged between the assembly and the pressure accumulator. The valve arrangement can be activated by a control unit and can be switched between a compressor mode and a starter mode. As in DE 1 281 752 A1, DE 24 40 446 A1 also assumes that the output torque of the assembly in starter mode is sufficient to start the engine in any crank angle position.

Thus, axial piston machines with a relatively large number of cylinders are suitable in principle as starter motors, but they are technically complex and therefore expensive. In addition, the installation space requirement also increases with the number of cylinders, such that that it is often not possible to use them in the case of a limited installation space, especially where the intention is to retrofit them to existing drive equipment. Axial piston machines with a small number of cylinders, for example, with one or two cylinders, have not heretofore been found to be suitable as starter motors.

### SUMMARY OF THE INVENTION

Generally speaking, it is an object of the present invention to provide a pneumatic starter device for internal combustion engines and a method for operating the same that ensures that even assemblies with a small number of cylinders, e.g., one or two cylinders, reliably provide sufficient output torque to start the internal combustion engine for startup in starter mode.

Output torque, particularly that of piston machines with a small number of cylinders, depends significantly on the respective crank angle position. That is, there are crank angle ranges in which there is no torque or insufficient torque to start the internal combustion engine, and there are crank angle ranges in which the output torque of the piston machine is sufficient. Since the crank angle position that can arise when the internal combustion engine and the piston machine that is drive-connected thereto are switched off is fundamentally random, restarting of the internal combustion engine by means of the pneumatic starter device is not possible under unfavorable conditions.

In accordance with embodiments of the present invention, a pneumatic starter device for internal combustion engines includes a cylinder-piston assembly that can be operated either as a compressor or as a motor and can be drive-connected to the internal combustion engine. In addition, a pressure accumulator and valve arrangement can be associated with the cylinder-piston assembly. The valve arrangement can be arranged between the cylinder-piston assembly and the pressure accumulator, and can be activated by a control unit. In addition, the valve arrangement can be switched between a compressor mode and a starter mode. The current crank angle position of the cylinder-piston assembly can be determined by means of at least one suitable sensor and transmitted to the control unit. Before being started up in starter mode, the cylinder-piston assembly can be set to a preferred crank angle position, such that it is in a range that can produce a maximum output torque.

As a result, even cylinder-piston assemblies having a small number of cylinders, e.g., one or two cylinders, can be reliably used as starter motors for internal combustion engines and to ensure reliable operation thereof. This is because the cylinder-piston assembly always makes available its maximum torque for startup in starter mode, and the torque is designed for starting the internal combustion engine.

The range for the preferred crank angle position is approximately 15° to 115° (20° to 90° is particularly preferable) from top dead center of a cylinder of the cylinder-piston assembly. In these crank angle ranges, the combination of the inertia of the internal combustion engine to be started and of the available driving torque from the cylinder-piston assembly is such that this compound drive assembly can fully crank over. If, on the other hand, the inertia of the internal combustion engine is too great, the output torque of the cylinder-piston assembly is too low, or the available time (in degrees of crankshaft angle) is too short, cranking over does not take place and a starting process is not possible.

According to an embodiment of the present invention, the cylinder-piston assembly can be stopped in the preferred crank angle position when the internal combustion engine is switched off, and the cylinder-piston assembly can be locked until startup in starter mode. The preferred crank angle position is optimally designed for the respective combination of the internal combustion engine and the cylinder-piston assembly. This means that a separate device that actively sets the assembly to the preferred crank angle position is not required.

The current crank angle position can be determined by means of a toothed disk connected to the crankshaft of the cylinder-piston assembly or by means of a reference mark on the output shaft of the cylinder-piston assembly and an associated sensor. Alternatively, the current crank angle position of the cylinder-piston assembly can also be determined indirectly, e.g., by measuring the pressure in the cylinder or crankcase of the cylinder-piston assembly.

According to another embodiment, as the internal combustion engine runs down, i.e., after the internal combustion engine has been switched off, the cylinder-piston assembly can be decoupled from the internal combustion engine upon reaching the preferred angular position and locked in this position.

The preferred crank angle position can be set, for example, by means of a slipping mode of the clutch, which is situated between the pneumatic cylinder-piston assembly and the transmission of the vehicle.

According to a further inventive embodiment, the cylinder-piston assembly can be set to the preferred crank angle position by means of a separate driving device before startup in starter mode. In another embodiment, in order for existing devices to be used as much as possible such that synergies with existing components can be exploited, the cylinder-piston assembly can be set to the preferred crank angle position by means of an electric starter device, which is furthermore associated with the internal combustion engine. This crank angle position can allow the internal combustion engine to be restarted with a maximum output torque of the pneumatic cylinder-piston assembly.

According to a still further embodiment, in the case where an electric starter device of this kind is present, the cylinder-piston assembly can be operated jointly with the electric starter device in a starter mode, with the two starter devices giving assistance to each other by means of a driving action.

The invention is particularly suitable for controlling pneumatic starter devices in which the cylinder-piston assembly has fewer than three cylinders.

According to an embodiment of the invention, the pneumatic starter device for internal combustion engines includes a cylinder-piston assembly that can be operated either as a compressor or as a motor and is drive-connected to the internal combustion engine. A pressure accumulator and a valve arrangement can be associated with this cylinder-piston assembly. The valve arrangement can be arranged between the cylinder-piston assembly and the pressure accumulator, and can be activated by a control unit and switched between a compressor mode and a starter mode. Before the cylinder-piston assembly is started up in starter mode, the cylinder-piston assembly can be set to the preferred crank angle position, where the preferred crank angle position is in the range that can produce a maximum output torque.

As explained above, the pneumatic starter device makes it possible to use assemblies with very few cylinders, e.g., one or two cylinders, because the problem of an insufficient output torque in the case of an unfavorable crank angle position is circumvented by the fact that a favorable crank angle position is always set before the cylinder-piston assembly is started up in starter mode.

According to one embodiment of the invention, to set the cylinder-piston assembly to a favorable crank angle position, a locking mechanism can be used which can be activated by the control unit to hold the cylinder-piston assembly firmly in the preferred crank angle position, or can be deactivated to release the cylinder-piston assembly. When the internal combustion engine and hence the cylinder-piston assembly drive-connected thereto are switched off, the assembly is halted and locked in the preferred crank angle position. This ensures that the output torque designed for the starting operation is available for the restart. Theoretically, this can be accomplished by stopping the internal combustion engine in a position in which the cylinder-piston assembly that is drive-connected thereto occupies the preferred crank angle position.

According to another embodiment, a selector clutch can be arranged between the assembly and the internal combustion engine. This makes it possible to decouple the assembly from the internal combustion engine and to halt and lock it in the preferred crank angle position independently of the engine. For optimum functioning, it is important to know the run-on behavior of the cylinder-piston assembly in the time between the opening of the clutch and the stationary condition thereof in different operating states. This running on, i.e., the reduction in rotational speed down to the stationary condition, is dependent on the inertia of the moving parts of the cylinder-piston assembly that are being used in each individual case and on the input element of the clutch. The locking mechanism should be actuated only when the cylinder-piston assembly has come almost completely to a halt. This can be determined by measuring the rotational speed or angular velocity of the output shaft of the cylinder-piston assembly.

According to one embodiment, the locking mechanism can have a locking pin, which can be introduced by means of an actuator into a bore in the output shaft of the cylinder-piston assembly. The position of the bore can correspond to an operating position of the pistons of the cylinder-piston assembly, which allows restarting of the internal combustion engine in a starter mode of the cylinder-piston assembly.

According to another embodiment, the locking mechanism can have a piston, which can be actuated by an actuator and has a flat end, which can be placed on a flat surface on the output shaft of the cylinder-piston assembly. The position of the flat surface on the output shaft can correspond to an operating position of the pistons of the cylinder-piston assembly that allows restarting of the internal combustion engine in a starter mode of the cylinder-piston assembly.

According to a further embodiment, setting the cylinder-piston assembly can involve an electric starter device, e.g. a conventional electric starter device, which is associated with the internal combustion engine and by means of which the cylinder-piston assembly drive-connected to the internal combustion engine can be set to the preferred crank angle position before being started up in starter mode. The starting operation may then proceed by initially activating the electric starter. At the instant when the cylinder-piston assembly drive-connected to the internal combustion engine occupies the preferred crank angle position, it is activated and either assists the electric starter device or takes over the starting function completely.

The pneumatic starter device preferably has at least one sensor connected to the control unit for detecting the current crank angle position.

The device according to the invention is particularly suitable for pneumatic starting devices in which the cylinder-piston assembly has fewer than three cylinders.

Still other objects and advantages of the present invention will in part be obvious and will in part be apparent from the specification.

The present invention accordingly comprises the various steps and the relation of one or more of such steps with respect to each of the others, and embodies features of construction, combinations of elements, and arrangement of parts which are adapted to effect such steps, all as exemplified in the following detailed disclosure, and the scope of the invention will be indicated in the claims.

### BRIEF DESCRIPTION OF THE DRAWINGS

For a fuller understanding of the inventive embodiments, reference is had to the following description taken in connection with the accompanying drawings in which:

FIG. 1 is a block diagram of a pneumatic starter device for an internal combustion engine having a locking mechanism in accordance with an embodiment of the present invention;

FIG. 2 is a block diagram of a pneumatic starter device for an internal combustion engine having an additional, conventional electric starter device in accordance with an embodiment of the present invention;

FIG. 3 is a schematic representation of a first locking mechanism in accordance with an embodiment of the present invention; and

FIG. 4 is a schematic representation of a second locking mechanism in accordance with an embodiment of the present invention.

### DETAILED DESCRIPTION OF THE PREFERRED EMBODIMENTS

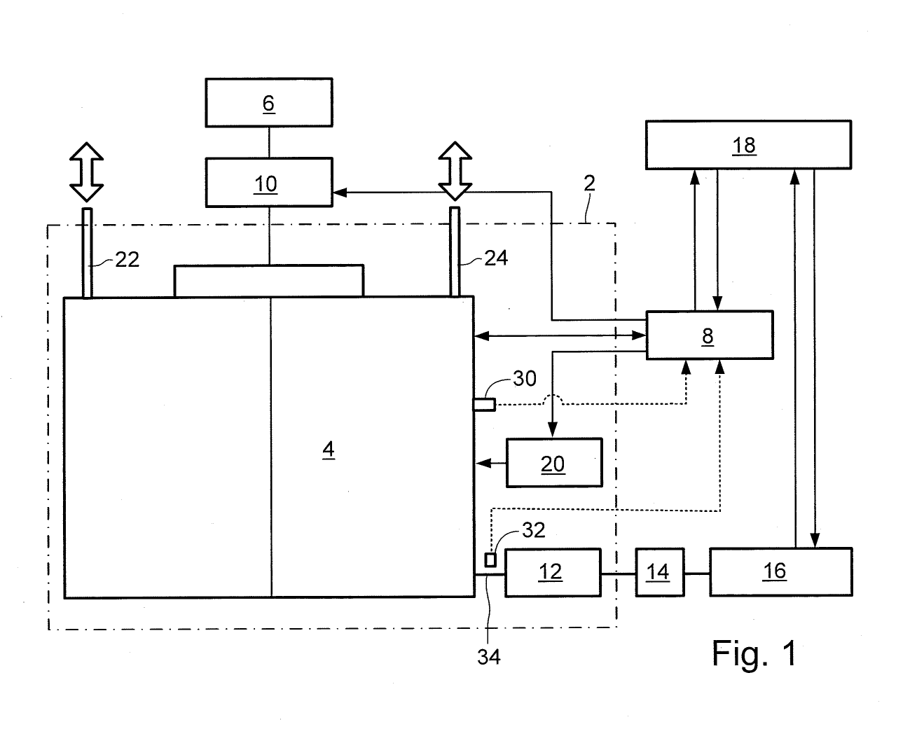

FIG. 1 shows a pneumatic starter device 2 having a two-cylinder cylinder-piston assembly 4, which can be operated either as a compressor or as a motor. Cylinder-piston assembly 4 and a valve arrangement 10 can be associated with a pressure accumulator 6. Valve arrangement 10 can be arranged between assembly 4 and pressure accumulator 6, and can be activated by a control unit 8. In addition, valve arrangement 10 can be switched between a compressor mode and a starter mode. Cylinder-piston assembly 4 can be drive-connected to an internal combustion engine 16 by means of a selector clutch 12 and, if appropriate, a transmission 14.

In the illustrative embodiment shown, control unit 8 is operatively connected to cylinder-piston assembly 4 and an engine control unit 18 by control lines and sensor lines. Engine control unit 18 can control the functions of internal combustion engine 16 in a suitable manner. Control unit 8 and engine control unit 18 can also be combined to yield an integrated overall controller.

Cylinder-piston assembly 4 can be assigned a locking mechanism 20, which can interact with one of the jointly moved functional elements of cylinder-piston assembly 4, e.g. the crankshaft, the connecting rod, or the piston of one of the two cylinders. This serves to lock cylinder-piston assembly 4 in a preferred crank angle position, such that it is in a range that can produce a maximum output torque. For example, this range can include 20° to 90° of crank angle from top dead center of each of the two cylinders of cylinder-piston assembly 4.

The current crank angle position can be determined by means of a toothed disk connected to the crankshaft of cylinder-piston assembly 4 or simply by means of a reference mark on output shaft 34 of cylinder-piston assembly 4 and an associated sensor 32. Sensor 32 can be connected to control unit 8 by a sensor line indicated in dashed lines. From the signals of sensor 32, it is also possible to determine the rotational speed or angular velocity of the output shaft of cylinder-piston assembly 4. This allows locking mechanism 20 to be activated at an optimum time when the rotational speed of cylinder-piston assembly 4 is low.

As an alternative, the current crank angle position of cylinder-piston assembly 4 can also be determined indirectly, e.g., by measuring the air pressure in the cylinder or crankcase of the cylinder-piston assembly. A pressure sensor 30 for this purpose is likewise connected to control unit 8 by a sensor line in FIG. 1, indicated by dashed lines.

Pneumatic starter device 2 operates as follows: in normal driving mode, internal combustion engine 16 drives cylinder-piston assembly 4 via transmission 14 and closed clutch 12, the two cylinders of cylinder-piston assembly 4 drawing in air via associated lines 22 and 24 and charging pressure accumulator 6 with compressed air via appropriately switched valve arrangement 10 until a predetermined pressure prevails in accumulator 6 (a compressor mode). Cylinder-piston assembly 4 can then be operated in a bypass mode, for example, in which it does not consume any power or only a little power. In the illustrative embodiment shown, there is also the possibility of decoupling cylinder-piston assembly 4 at times by means of clutch 12.

When internal combustion engine 16 is switched off, cylinder-piston assembly 4 can be separated therefrom by opening clutch 12. Cylinder-piston assembly 4 can be locked in this position by locking mechanism 20 if the assembly is occupying a preferred crank angle position. For this purpose, output shaft 34 of cylinder-piston assembly 4, which is connected to clutch 12, can be locked, for example.

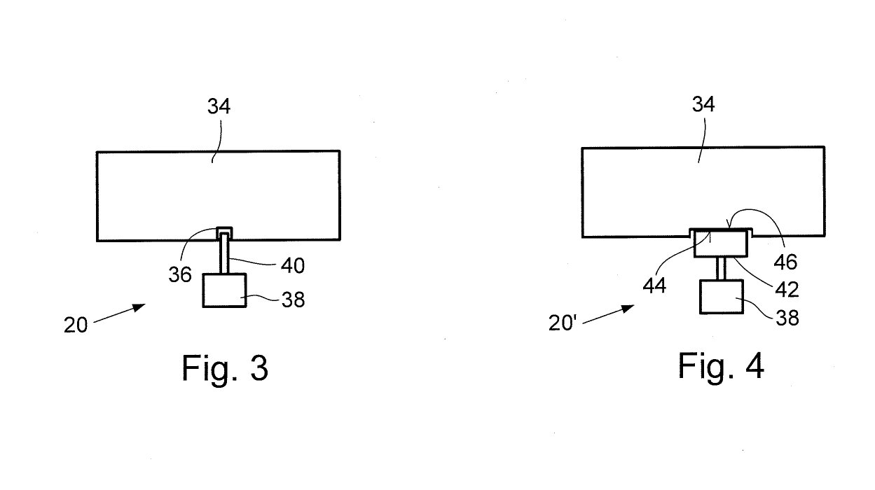

According to a first illustrative embodiment of locking mechanism 20 shown in FIG. 3, the locking of output shaft 34 of cylinder-piston assembly 4 can be accomplished by positive engagement. Here, locking is accomplished by means of a pin 40, which can be arranged so as to be fixed relative to the housing and movable axially by an actuator 38. After the opening of clutch 12 and a reduction in the rotational speed of output shaft 34 of cylinder-piston assembly 4 to almost zero, pin 40 can be pressed into a flat bore 36 in output shaft 34. The position of bore 36 in output shaft 34 of cylinder-piston assembly 4 can be chosen such that the pistons of cylinder-piston assembly 4 occupy a position that is, as described above, optimal for restarting internal combustion engine 16. If pin 40 is designed with a rounded tip, the mechanical load on it can advantageously be reduced.

Alternatively, as shown in FIG. 4, the locking element of locking mechanism 20′ can have a piston 42. Free flat end 46 of piston 42 can be pressed against output shaft 34 of cylinder-piston assembly 4 by an associated actuator 38. Output shaft 34 can have a flat surface 44, which can deviate from the circular shape and on which end 46 of piston 42 can act. As soon as the rotational speed of output shaft 34 has fallen almost to a standstill after the opening of clutch 12, the locking element of locking mechanism 20′, which is designed as a piston 42, can be pressed against output shaft 34 of cylinder-piston assembly 4, with the result that end 46 of piston 42 comes to rest on flat surface 44 of output shaft 34. This can make it more difficult for output shaft 34 to rotate further and ultimately holds it in a stationary position that can correspond to an optimum position of the pistons of cylinder-piston assembly 4 for restarting internal combustion engine 16.

To restart internal combustion engine 16, valve arrangement 10 and the valves belonging to the two cylinders of cylinder-piston assembly 4 are switched over to starter mode by control unit 8. the locking mechanism is adjusted to an unlocking position, and the clutch is closed. Cylinder-piston assembly 4, which is in the preferred crank angle position owing to the previous setting operation, is now driven by the compressed air from pressure accumulator 6. Cylinder-piston assembly 4 can start internal combustion engine 16, with lines 22 and 24 releasing the air to the outside. Once internal combustion engine 16 has been started, cylinder-piston assembly 4 can be switched back to compressor mode.

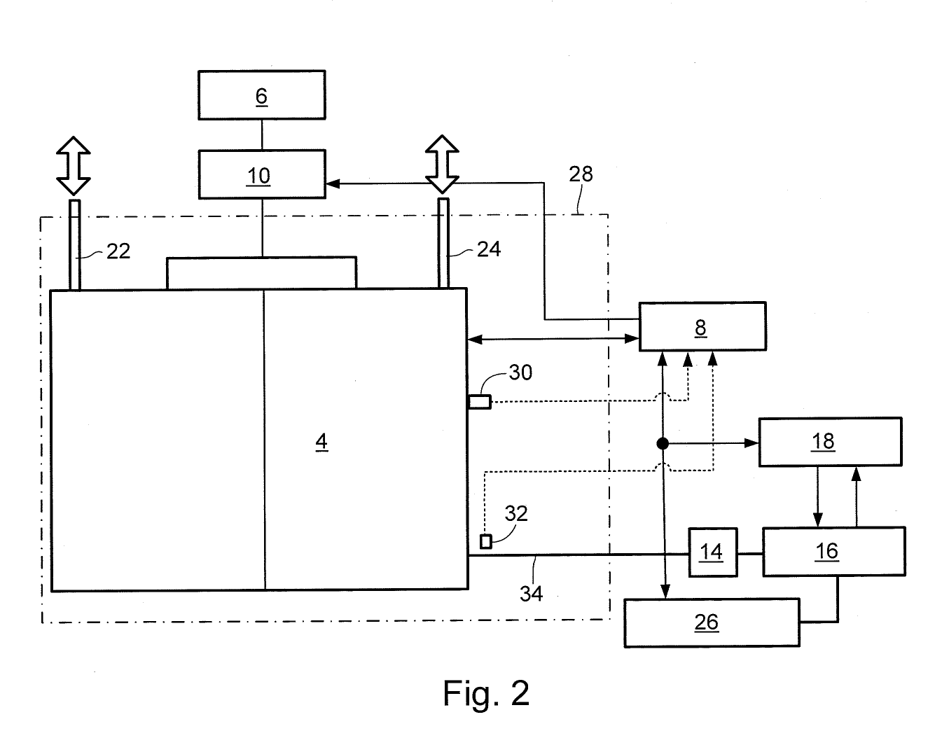

FIG. 2 shows a pneumatic starter device 28 similar to that in FIG. 1. However, it differs from the latter in that there is no locking mechanism or clutch. Instead, internal combustion engine 16 is assigned an additional electric starter device 26. Identical functional elements of the device are denoted by identical reference numbers to those in FIG. 1.

The compressor mode of pneumatic starter device 28 shown in FIG. 2 can correspond to the compressor mode described with reference to FIG. 1. When internal combustion engine 16 is switched off, cylinder-piston assembly 4, which is in fixed drive connection with internal combustion engine 16, can be set to an arbitrary crank angle position dependent on the stopping position of internal combustion engine 16.

To restart internal combustion engine 16, the engine can be turned by associated electric starter device 26. As soon as cylinder-piston assembly 4 reaches a preferred crank angle position, valve arrangement 10 and the cylinder valves belonging to the assembly are switched to their positions for starter mode, such that cylinder-piston assembly 4 can be driven by the compressed air from pressure accumulator 6. Cylinder-piston assembly 4 can either assist electric starter device 26 or can take over the starting operation entirely. Similar to FIG. 1, the preferred crank angle position of pneumatic starter device 28 of FIG. 2 is preferably detected by control unit 8 by means of at least one of two sensors 30, 32.

It will thus be seen that the objects set forth above, among those made apparent from the preceding description, are efficiently attained, and since certain changes may be made in the above constructions without departing from the spirit and scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed is:

1. A method for operating a pneumatic starter device for an internal combustion engine, the internal combustion engine having a cylinder-piston assembly operable as one of a compressor and a motor and is drive-connected to the internal combustion engine, a pressure accumulator associated with the cylinder-piston assembly, and a valve arrangement, between the cylinder-piston assembly and the pressure accumulator that is actuable by a control unit and switchable between a compressor mode and a starter mode, the method comprising determining a current, first crank angle position of the cylinder-piston assembly using at least one sensor, transmitting the first crank angle position to the control unit, and before the cylinder-position assembly is started up in starter mode, setting the cylinder-piston assembly to a second crank angle position, in a range of positions that produce a maximum output torque.

2. The method of claim 1, wherein the range of positions is 15° to 110° of crank angle from top dead center of a cylinder of the cylinder-piston assembly.

3. The method of claim 1, further comprising stopping, the cylinder-piston assembly in the second crank angle position and locking until startup in starter mode when the internal combustion engine is switched off.

4. The method of claim 3, further comprising decoupling the cylinder-piston assembly from the internal combustion engine and locking upon reaching the second crank angle position as the internal combustion engine runs down after having been switched off.

5. The method of claim 1, further comprising setting the cylinder-piston assembly to the second crank angle position using a separate driving device before startup in starter mode.

6. The method of claim 1, further comprising setting the cylinder-piston assembly to the second crank angle position using an electric starter device associated with the internal combustion engine.

7. The method of claim 1 6, further comprising operating the cylinder-piston assembly jointly with the electric starter device in starter mode.

8. The method of claim 1, wherein the cylinder-piston assembly has fewer than three cylinders.

9. A pneumatic starter device for an internal combustion engine, the device comprising a cylinder-piston assembly, operable as one of a compressor and a starter motor and drive-connected to the internal combustion engine, a pressure accumulator associated with the cylinder-piston assembly, and a valve arrangement between the cylinder-piston assembly and the pressure accumulator, the valve arrangement being actuable by a control unit and switchable between a compressor mode and a starter mode, wherein before being started up in starter mode, the cylinder-piston assembly is settable to a crank angle position that is in a range of positions that produce a maximum output torque.

10. The pneumatic starter device of claim 9, further comprising a locking mechanism, actuable by the control unit and operable to one of hold the cylinder-piston assembly in the crank angle position and release it.

11. The pneumatic starter device of claim 9, further comprising a selector clutch arranged between the cylinder-piston assembly and the internal combustion engine.

12. The pneumatic starter device of claim 10, wherein the locking mechanism has a locking pin, insertable by an actuator into a bore in an output shaft of the cylinder-piston assembly, the position of the bore corresponding to an operating position of pistons of the cylinder-piston assembly that allows restarting of the internal combustion engine in starter mode of the cylinder-piston assembly.

13. The pneumatic starter device of claim 10, wherein the locking mechanism has a piston, actuable by an actuator , the piston having a flat end, disposable on a flat surface on an output shaft of the cylinder-piston assembly, the position of the flat surface on the output shaft corresponding to an operating position of pistons of the cylinder-piston assembly that allows restarting of the internal combustion engine in starter mode of the cylinder-piston assembly.

14. The pneumatic starter device of claim 9, further comprising an electric starter device associated with the internal combustion engine, and operable to set the cylinder-piston assembly to the crank angle position before being started up in starter mode.

15. The pneumatic starter device of claim 9, further comprising at least one sensor connected to the control unit for detecting a current crank angle position.

16. The pneumatic starter device of claim 9, wherein the cylinder-piston assembly has fewer than three cylinders.
